(19) United States
(12) Patent Application Publication
(10) Pub. No.: US 2015/0018045 A1
(43) Pub. Date: Jan. 15, 2015

(54) COVER DEVICE AND PORTABLE TERMINAL HAVING THE SAME

(71) Applicant: Samsung Electronics Co., Ltd., Gyeonggi-do (KR)

(72) Inventors: Kyung-Hoon CHA, Seoul (KR); Seong-Woon KANG, Gyeonggi-do (KR); Young-Woong KIM, Seoul (KR); Sung-Jin PARK, Seoul (KR); Kyu-Suk LEE, Gyeonggi-do (KR); Jong-In LEE, Gyeonggi-do (KR)

(73) Assignee: Samsung Electronics Co., Ltd.

(21) Appl. No.: 14/330,430

(22) Filed: Jul. 14, 2014

(30) Foreign Application Priority Data
Jul. 12, 2013 (KR) 10-2013-0082419

(51) Int. Cl. H04M 1/02

(52) U.S. Cl. CPC H04M 1/0266; H04M 1/0216
USPC 455/566

(57) ABSTRACT

A cover device is disclosed, and includes a cover member having an output unit on a surface thereof, and rotatably coupled with a touch panel; and an electrostatic capacitance generating unit which varies electrostatic capacitance at a touch position of the touch panel according to a touch on the output unit. A cover device also includes an output unit; and a transparent conductive film member provided on front and rear surfaces of the output unit, such that the transparent conductive film member is folded and provided on the front and rear surfaces of the output unit, so as to generate electrostatic capacitance at the same position.

### PRIORITY

This application claims priority under 35 U.S.C. §119(a) to Korean Patent Application Serial No. 10-2013-0082419, which was filed in the Korean Intellectual Property Office on Jul. 12, 2013, the entire content of which is incorporated herein by reference.

### BACKGROUND

1. Field of the Invention

The present invention generally relates to a cover device and a portable terminal having the same.

2. Description of the Related Art

Recently, various electronic devices have become more popular. Portable devices (hereinafter, referred to as “portable terminal”) such as portable terminals, MP3 players, Portable Multimedia Players (PMP), electronic book readers, and the like have been generally used, which a user can carry while using various contents. Such a portable terminal has various functions including photographing, reproduction of music and videos, multimedia, games, and the like, as well as a wireless data transmission and reception function. The portable terminal has a touch screen arranged on a front surface thereof, through which a user can use various functions. In the case of a smartphone, a touch screen capable of responding to a touch is provided on an entire front surface of the smartphone.

However, the touch screen, which is wholly exposed on the front surface of the portable terminal or an external case of the portable terminal during a carrying or use of the portable terminal, may be damaged due to scratching or impact. In order to prevent damage on the touch screen, various cases or covers (hereinafter, generally referred to as a “cover device”) are provided for the portable terminal. In the case where the conventional cover device covers the portable terminal, one cover device has an open type structure in that it covers side surfaces and a rear surface of the portable terminal and has a front portion thereof open in order to allow a person to use a touch screen of the portable terminal, or another cover device has a flip type structure of covering the entire portable terminal, in which a portion thereof covering a touch screen of the portable terminal can be open and closed in order to use the touch screen.

When using the open type cover device which allows the touch screen to be exposed, it is difficult to prevent the touch screen from being scratched or damaged. Further, when using a cover device having a flip type structure covering the touch screen, there is user inconvenience since a user must open and close a cover portion covering the touch screen each time when the touch screen is used. Furthermore, the flip-type cover device causes inconvenience for a user to open a cover thereof even when the user receives or sends a call. That is, the cover must to be opened every time in order for a user to use the portable terminal. Thereby, a flip hinge can be damaged as the cover is frequently open and closed. Further, when the touch screen is used, the open type cover device covering outer surfaces and the flip type cover device must allow the touch screen to be exposed to the outside. Also as a user makes contact for touching the touch screen, damage such as a scratch on the touch screen may result.

Further, in order to implement a touch input on a front surface of the flip cover, an additional device, such as the touch screen provided to the portable terminal, must be provided on the flip cover. This causes a thickness of the flip cover to increase and also a cost to highly increase. Moreover, a separate electric power source must be provided to the portable terminal in order to supply electric power to a separate touch screen provided to the flip cover, or an electric power source for the portable terminal should be used for the separate touch screen on the flip cover. When using the electric power source of the portable terminal for the touch screen on the flip cover, a consumption of the electric power is increased, thereby significantly reducing a time of using the portable terminal. Accordingly, inconvenience to a user in using the portable terminal results.

### SUMMARY

The present invention has been made to address the above-mentioned disadvantages and problems in the conventional art, and to provide at least the advantages described below. Accordingly, an aspect of the present invention is to provide a cover device and a portable terminal having the same, in which predetermined contents can be output even when a touch screen of the portable terminal is covered with the cover device. Another aspect of the present invention is to provide a cover device and a portable terminal having the same, which are capable of implementing an input and output even when a touch screen of the portable terminal is covered with the cover device.

In accordance with an aspect of the present disclosure, a cover device is provided. The cover device includes a cover member having an output unit on a surface thereof, and rotatably coupled with a touch panel; and an electrostatic capacitance generating unit which varies electrostatic capacitance at a touch position of the touch panel according to a touch on the output unit.

In accordance with another aspect of the present invention, a cover device is provided. The cover device includes an output unit; and a transparent conductive film member, wherein the transparent conductive film member is a continuous film and is provided on the front and rear surfaces of the output unit, so as to generate electrostatic capacitance at a same position.

In accordance with another aspect of the present invention, a portable terminal having a cover device is provided. The portable terminal includes a body including an input/output unit; and a cover member coupled with the body for covering the body, and provided with an auxiliary output unit on a front surface thereof, wherein the cover member includes an electrostatic capacitance generating unit which implements an input to the input unit of the input/output unit according to a touch on the auxiliary output unit.

In accordance with another aspect of the present invention, a portable terminal having a cover device is provided. The portable terminal includes a body including an input/output unit; and a cover member coupled with the body for covering the body, and provided with an auxiliary output unit on a front surface thereof, wherein the cover member includes a transparent conductive film member which is provided on front and rear surfaces of the auxiliary output unit and generates electrostatic capacitance at a same position.

### BRIEF DESCRIPTION OF THE DRAWINGS

The above and other aspects, features, and advantages of the present invention will be more apparent from the following detailed description taken in conjunction with the accompanying drawings, in which:

FIGS. 1A and 1B are perspective views illustrating a portable terminal having a cover unit according to embodiments of the present invention;

FIG. 2 is a perspective schematic view illustrating the portable terminal shown in FIG. 1, in which a cover member is provided to an input/output unit of the portable terminal;

FIGS. 3A and 3B are side schematic views illustrating the portable terminal shown in FIG. 1, in which an implementation of an input is achieved according to a folding or an unfolding of the cover member;

FIG. 4 is a block diagram illustrating the portable terminal shown in FIG. 1, in which a controller is executed according to a folding or an unfolding of the cover member;

FIGS. 5A and 5B are sectional views illustrating the portable terminal shown in FIG. 3 according to a first embodiment of the present invention, in which the portable terminal has a cover member;

FIGS. 6A-6C are views illustrating examples of a fixed guide member of the portable terminal shown in FIG. 5 according to the embodiment of the present invention;

FIGS. 7A and 7B are sectional views illustrating the portable terminal shown in FIG. 1, in which another example of the cover member, particularly, an electrostatic generating unit, is provided to the portable terminal;

FIGS. 8A and 8B are sectional views illustrating the portable terminal shown in FIG. 7, in which another example of the electrostatic generating unit, particularly, a supporting unit, is provided to the portable terminal;

FIG. 9 is a sectional view illustrating the portable terminal shown in FIG. 8, in which a fixed guide member is provided to the portable terminal;

FIGS. 10A and 10B are sectional views illustrating the portable terminal shown in FIG. 9, in which another example of a fixed guide member is provided to the portable terminal;

FIG. 11 is a schematic view illustrating a transparent conductive film member provided for the cover member in the portable terminal shown in FIG. 1;

FIG. 12 is a schematic view illustrating the cover member provided with the transparent conductive film member shown in FIG. 11;

FIGS. 13A-13D are views illustrating an example of the transparent conductive film member for implementing an input in the cover member shown in FIG. 12;

FIG. 14 is a sectional view schematically illustrating the transparent conductive film member shown in FIG. 13, in which the transparent conductive film member is provided to the cover member;

FIG. 15 is a sectional view illustrating the transparent conductive film member shown in FIG. 13, in which the transparent conductive film member is provided with a conductive protection film;

FIGS. 16A and 16B are sectional views illustrating another example of the transparent conductive film member shown in FIG. 13, in which the transparent conductive film member has a different pattern on a rear surface thereof;

FIG. 17 is a flowchart illustrating an operation of the portable terminal shown in FIG. 1 according to a folding or an unfolding of the cover unit; and

FIG. 18 is a flowchart in which the flowchart of FIG. 17 is briefly shown.

### DETAILED DESCRIPTION OF EMBODIMENTS OF THE PRESENT INVENTION

Hereinafter, various embodiments of the present invention will be described with reference to the accompanying drawings. In the description, a thickness of lines or a size of structural elements in the drawings may be exaggeratedly shown for a convenience and definition of description. Further, terms to be described later are defined in consideration of functions in various embodiments of the present invention, and may be changed according to a user, an intention of an operator, or a convention. Therefore, the definitions of the terms should be determined based on contents throughout the specification.

Furthermore, in the description of the embodiments of the present invention, ordinal numbers such as first and second are used, but are to merely distinguish objects having the same name from one another. Orders thereof may be arbitrarily determined and the description of a preceding object will be applied to a following object. In the description of the embodiments of the present invention, in addition, the terms are used to describe the respective embodiments, and are not intended to limit the embodiments. A singular expression may include a plural expression unless they are definitely different in a context. In the description, it should be understood that the terms “include” or “have” indicate existence of a feature, a number, a step, an operation, a structural element, parts, or a combination thereof, and do not previously exclude the existence or probability of addition of one or more other features, numbers, steps, operations, structural elements, parts, or combinations thereof.

In the following description of a cover device 10 and a portable terminal 100 having the same according to an embodiment of the present invention, a structure of the portable terminal 100 of the present disclosure will firstly be described, and then the cover device 10 provided to the portable terminal 100 will be described.

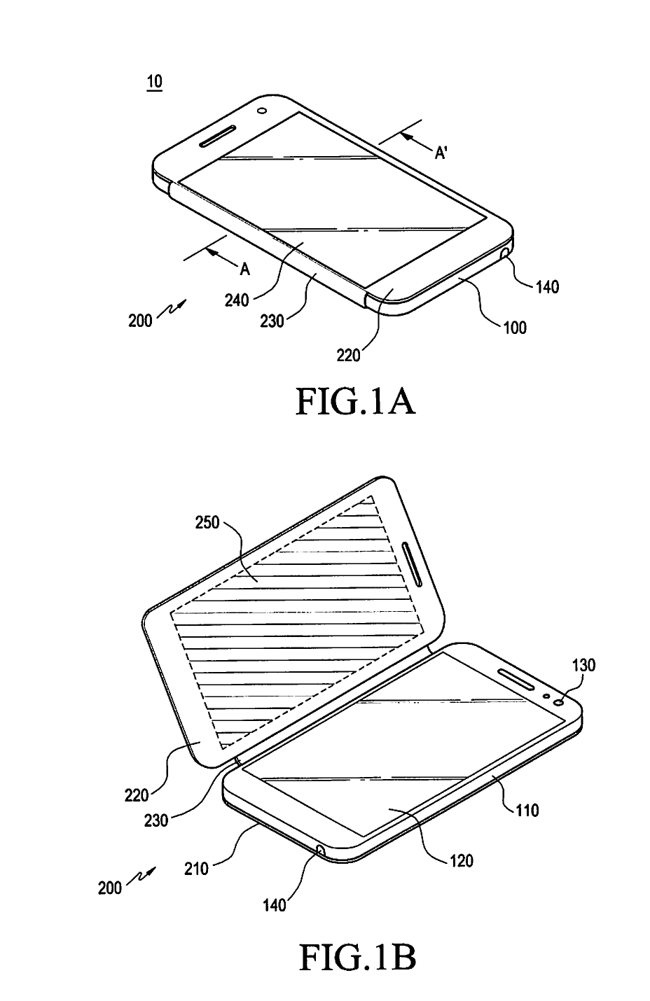

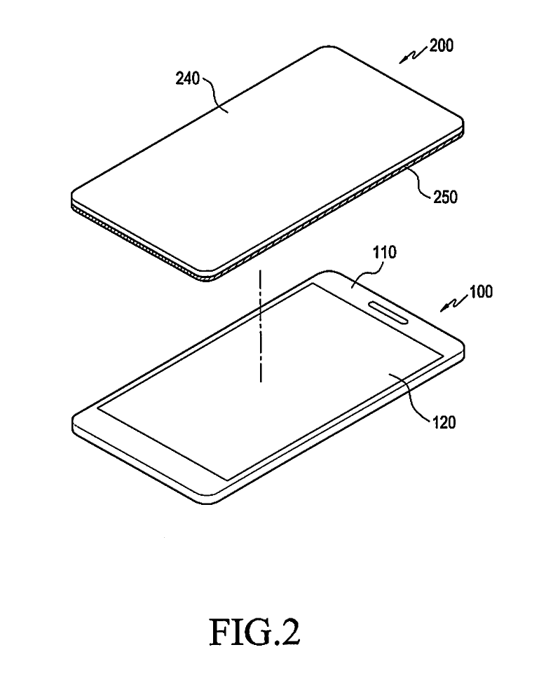

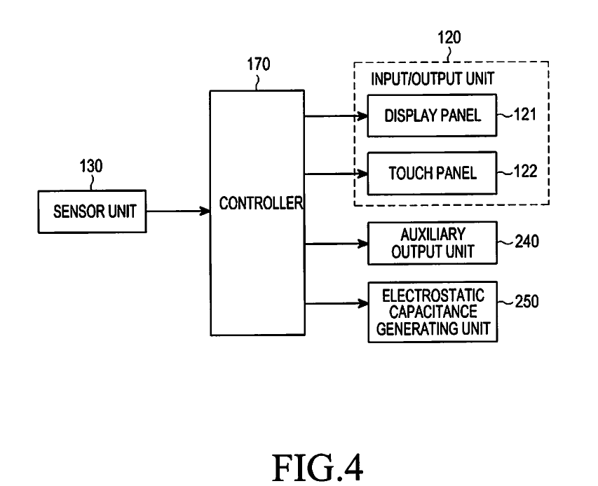

FIGS. 1A and 1B are perspective views illustrating a portable terminal having a cover unit according to embodiments of the present invention, and FIG. 2 is a schematic view illustrating the portable terminal shown in FIG. 1, in which a cover member 220 is provided over an input/output unit of the portable terminal. Referring to FIGS. 1 and 2, a device 10 according to embodiments of the present invention includes a portable terminal 100, and a cover device 10 (hereinafter, referred to as a “cover unit 200”) covering the portable terminal 100. The portable terminal 100 includes a body 110 which is provided with various modules including a communication module, a multimedia module, a camera module, an audio module, a sensor unit 130, and the like according to a function or a structure of the portable terminal 100. In an embodiment of the present invention, the portable terminal 100 includes a bar type body 110, a large input/output unit 120 arranged on a front surface of the body 110, and a plurality of sensor units 130. Further, the portable terminal 100 includes an internal circuit module for various functions, and various modules (not shown) connected to the internal circuit module, for example, camera modules arranged on front and back surfaces of the body 110, a button module having a power-on/off function, a sound control function, a specific function, a connection module for a connection with an external device, and a transmission and reception module. Also, the portable terminal 100 includes a controller 170 (see FIG. 4) for controlling the modules.

As described above, the body 110 is provided with the input/output unit 120, an input unit 140, the plurality of sensor units 130 (herein, the sensor units 130 refer to elements of detecting a folding of the cover unit 200, and various kinds of sensor units may be further provided), and the controller 170.

The input/output unit 120 is provided on the front surface of the body 110, and receives an input corresponding to a contact or proximity of an object so as to implement an output on a screen. The input/output unit 120 of the present invention may receive an input caused by a finger or the input unit 140 having an electric charge, and display an output according to the input.

The input/output unit 120 receives at least one contact input through various objects, for example, a user's body, e.g., fingers, and a touchable input means, e.g., the input unit 140 such as an electronic pen (stylus pen). Further, the input/output unit 120 may receive a continuous movement of at least one touch among the touches. In an embodiment of the present invention, a “touch” is not limited to a direct touch of the user's body or the input unit 140 on the input/output unit 120, but may include a hovering on the input/output unit 120. A distance of the hovering detected by the input/output unit 120 can be changed according to the performance or the structure of the portable terminal 100.

In the embodiment of the present invention, the input/output unit 120 includes a display panel 121 and a touch panel 122 (see FIG. 4).

The display panel 121 includes a Liquid Crystal Display (LCD) panel, and an Active Matrix Organic Light Emitting Diodes (AMOLED) panel, and displays various images corresponding to various operation states, execution of an applications, and services which are implemented by the portable terminal 100.

The touch panel 121 may include an electrostatic capacitance type touch panel 122 (hereinafter, referred to as a touch panel) and an electromagnetic resonance type touch panel (not shown). The touch panel 122 is configured to detect a touch of an object such as a hand having a fine electric charge, and is disposed under the display panel 121. The electrostatic capacitance type touch panel 122 is a panel such as an Indium Tin Oxide (ITO) panel in which a thin metal conductive substance, i.e. ITO, is coated on both surfaces of a glass sheet so that electric current is applied on the surface of the glass sheet, and a dielectric capable of storing an electric charge is coated on the glass sheet. In the touch panel 122, when an object touches the display panel 121, a predetermined amount of electric charges are moved to a touched position of the touch panel 221 by means of static electricity. The touch panel 122 recognizes a variation of the electric current depending on the movement of the electric charges, so as to detect the touch position. The touch panel 122 is capable of detecting all touches which may cause static electricity. Accordingly, the touch panel 122 detects a touch by a user's hand or the input unit 140 such as the stylus pen.

The Electro-Magnetic Resonance (EMR) type touch panel (not shown) is disposed together with the touch panel 122 under the display panel 121, and operates in association with the input unit 140 provided to the body 110 to detect a touch of the input unit 140. The EMR type touch panel includes an electronic induction coil sensor (not shown) having a grid structure in which a plurality of loop coils are arranged in a first direction and a second direction intersecting with the first direction, and an electronic signal processor (not shown) for sequentially providing alternate current signals, which have a predetermined frequency, to each loop coil of the electronic induction coil sensor. The EMR type touch panel is provided with a separate input unit 140 in which a resonance circuit capable of generating electric current based on electromagnetic induction is embedded. That is, when the input unit 140 with the resonance circuit embedded is located near the loop coil, a magnetic field transmitted from the corresponding loop coil generates electric current in the resonance circuit of the input unit 140, based on mutual electromagnetic induction. Based on the electric current, a coil constituting the resonance circuit in the input unit 140 generates an induction magnetic field, and the EMR type touch panel detects the induction magnetic field through the loop coil which is in a signal receiving state, so as to sense a proximity position or a touch position of the input unit 140.

As described above, in the case of the touch panel provided to the input/output unit 120 in the embodiment of the present invention, the input/output unit 120 to which two touch panels, particularly, the electrostatic capacitance type touch panel 122 and the EMR type touch panel, are provided has been described as an example. However, the touch panel is not limited thereto. For example, the input/output unit 120 may be constituted of both the electrostatic capacitance type touch panel 122 and the display panel 121, or various kinds of touch panels. The kinds and number of touch panels can be changed by any amount. Further, the electrostatic capacitance type touch panel is described as an example of the touch panel 122, but the touch panel is not limited thereto. For example, the input/output device 120 may be implemented in various types of touch panels such as a resistive type touch panel, an electrostatic capacitive type touch panel, an infrared type touch panel, an electromagnetic resonance type touch panel, and an acoustic wave type touch panel. Of course, the input/output device 120 may be implemented in a combination of two or more types of panels.

In the embodiment of the present invention, an operation of the input/output device 120 will be described. Operations of the display panel 121 and the touch panel 122 are determined according to a folding or an unfolding of the cover unit 100 as described below. For example, in a state where the cover unit 200 is folded (closed), a supply of electric power to the display panel 121 is interrupted and the display panel 121 of the input/output unit 120 is turned off and deactivated. On the other hand, in a state where the cover unit 200 is open, electric power is supplied to the display panel 121 and the display panel 121 is turned on and activated to display various menus. In the state where the cover unit 200 is folded or unfolded, when electric power is supplied to the touch panel 122 so as to activate the touch panel 122, the touch panel 122 can detect a touch on the display panel 121 and a touch on an auxiliary output unit 240.

The input unit 140 is detachably attached to the body 110, particularly, a lower end of the body 110, and a sensor unit 130 capable of detecting a folding of the cover unit is disposed on a front surface of the body 110, particularly, a vessel region provided along a periphery of the input/output unit 120, in such a manner to avoid an interference with the input/output unit 120.

The sensor unit 130 is a sensor for detecting a folding state of the cover unit 200, and detects whether the cover unit 200, particularly the cover member 220, is folded on the input/output unit 120 or is open. For example, the sensor unit 130 according to the embodiment of the present invention is disposed at a right upper corner of a front surface of the body 110, and includes a proximity sensor and a Hall IC. However, an installation position or a kind of the sensor unit 130 is not limited thereto. That is, if the sensor unit 130 is disposed at a position where it detects a folding of the cover member 220 and detects whether the cover member 220 is folded on the body 110, the installation position or the kind of the sensor unit 130 can be changed by any amount.

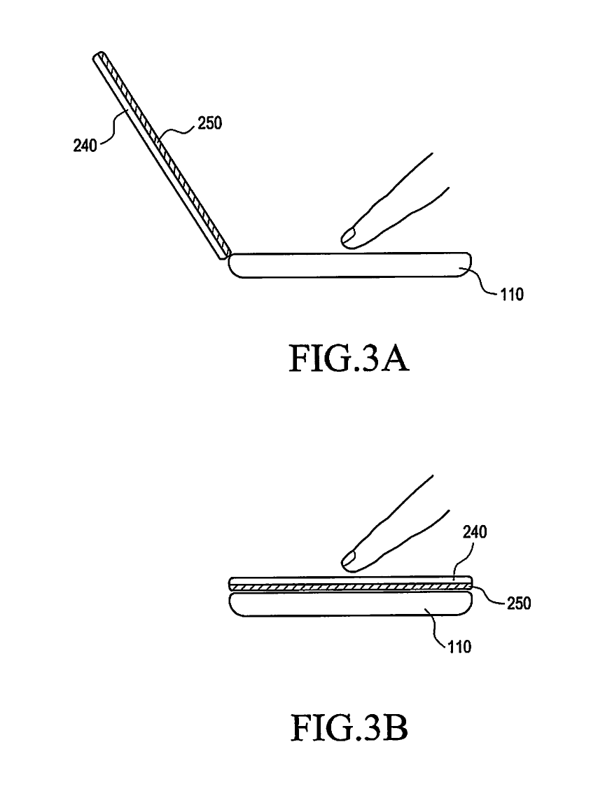

FIGS. 3A and 3B are side schematic views illustrating the portable terminal shown in FIG. 1, in which an implementation of an input is achieved according to a folding or an unfolding of the cover member, and FIG. 4 is a block diagram illustrating the portable terminal shown in FIG. 4, which shows a state where a controller is executed according to a folding or an unfolding of the cover member. Referring to FIGS. 3 and 4, the cover member 200 is detachably attached to the body 110, and is configured to open and close a front surface of the body 110. In the case where the cover unit 200 is coupled to the body 110, although it is not shown, a connector for electrically connecting the body 110 with the cover unit 200 may be provided in order to electrically connect the body 110 with an auxiliary output unit 240 provided to the cover unit 200. As described below, further, in the case where the cover unit 200, particularly a rear cover 210 of FIG. 1B, is integrally formed with the body 110, when the rear cover 210 is combined with a rear surface of the body 110, the portable terminal 100 may be electrically connected with the cover unit 200. Therefore, the electric power may be supplied to the auxiliary output unit 240 so that predetermined contents are output to the auxiliary output unit 240 according to the state of the portable terminal 100 and the cover unit 200 when the cover unit 200 is combined with the portable terminal 100. The cover unit 200 is configured to cover the input/output unit 120 in order to open and close the input/output unit 120. The cover unit 200 is provided with an auxiliary output unit 240 capable of displaying a screen including the predetermined contents, and is disposed on the front surface of the cover unit 200. A flip type cover will be described as an example of the cover unit 200 according to an embodiment of the present invention. Further, the flip type cover includes a one-piece type flip cover (referred to as a “book cover” or “quick cover”) integrated with the body 110 of the portable terminal 100 in the form of one body, and a separate type flip cover separated from the body 110 of the portable terminal 100. Further, the cover unit 200 may include a cover member 220 rotatably connected to the body 110 so as to cover the input/output unit 120 disposed on the front surface of the body 110. Such a structure may be changed and modified by any amount according to a shape of the cover unit 200 or a shape and a structure of the portable terminal 100 (the terms “one-piece” and “separate” will be described in detail below in the description of a rear cover 210).

Referring to FIGS. 1-4, a flip cover described above will be described as an example of the cover unit 200 according to one embodiment of the present invention. That is, the cover unit 200 is configured to have a front cover 220 (hereinafter, referred to as a “cover member 200” because the front cover corresponds to the cover member 220), a rear cover 210 and a connection member 230, so as to cover the front and rear surfaces of the body 110. As described above, however, according to the present invention, the cover unit 200 may be constituted of only the cover member 220. That is, the cover unit 200 may be constituted of the cover member 220 if the cover member 220 is configured to rotate around a side of the body 110, i.e., a rotation axis, so as to open and close the input/output unit 120.

The cover unit 200 is provided with the auxiliary output unit 240 for implementing an output depending on a detection of the touch panel 122, and includes an element 250 (an electrostatic capacitance generating unit in the first and second embodiments, and a transparent conductive film member in the third embodiment) which enables the touch panel 122 to react to a touch on the auxiliary output unit 240 in the state where the cover unit 200 is folded on the input/output unit 120. The cover unit 200 will be described in detail while describing embodiments of the cover member 220.

A controller 170 controls various modules provided in the body 110. For example, the controller 170 is configured to control a mobile communication module, a sub-communication module, a multimedia module, and the like provided in the body 110. In particular, the controller 170 controls operations of the input/output unit 120, the output unit 240 and the electrostatic capacitance generating unit 250 according to a detected signal of the sensor unit 130. That is, the controller 170 controls various structural elements provided in the body 110, and determines whether the input/output unit 120 and the auxiliary output unit 240, the electrostatic capacitance generating unit 250, or the transparent conductive film member 250 described below are made to be activated or deactivated, according to a signal applied to the sensor unit 130. For example, in the case where a signal is not applied to the sensor unit 130 (see FIG. 3A), the cover member 220 is far from the input/output unit 120 and the cover unit 200 is in a state of being open from the input/output unit 120. The controller 170 controls electric power supplied to the input/output unit 120 and the auxiliary output unit 240, the electrostatic capacitance generating unit 250, or the transparent conductive film member 250 of the cover unit 200 described above, according to a signal value, i.e., a signal value informing that a signal is not applied to the sensor unit 130. That is, in the case where the cover unit 200 is opened, the controller 170 turns the display panel 121 and the touch panel 122 on, controls the auxiliary output unit 240 to be deactivated. Accordingly, when predetermined data is output to the display panel 121 and the touch panel 122 recognizes a touch on the display panel 121, a predetermined signal value is displayed on the display panel 121 according to a touch signal. Further, as the auxiliary output unit 240 is deactivated and electric power is not supplied to the auxiliary output unit 240, an output through the auxiliary output unit 240 does not occur. Furthermore, although a touch on the electrostatic capacitance generating unit 250 or the transparent conductive film member 250 occurs, a value of the touch is not applied to the touch panel 122.

On the other hand, in the case where a signal is applied to the sensor unit 130 (see FIG. 3B), this indicates a state in which the cover unit 200 is folded on the input/output unit 120. That is, the cover unit 200 covers the input/output unit 120. The controller 170 controls electric power supplied to the input/output unit 120 of the sensor unit 130 and electric power supplied to the auxiliary output unit 240 and the electrostatic capacitance generating unit 250 (the transparent conductive film member 250 in another embodiment described below) according to the signal value applied to the sensor unit 130, i.e., the signal value informing that a signal is applied to the sensor unit 130. Accordingly, in the case where the cover member 220 covers the input/output unit 120, the controller 170 interrupts the electric power supplied to the display panel 121 so as to turn the display panel 121 off, and controls the touch panel 122 and the auxiliary output unit 240 to be turned on. Thereby, the predetermined data or contents are output through the auxiliary output unit 240 in the state where the cover member 220 covers the input/output unit 120.

In addition, the cover member 220 is provided with the electrostatic capacitance generating unit 250 or the transparent conductive film member 250. When a touch on the auxiliary output unit 240 occurs, the electrostatic capacitance generating unit 250 or the transparent conductive film member 250 is in contact with the activated touch panel 122 so as to provide a touch signal to the touch panel 122 according to the touch. Accordingly, the electrostatic capacitance generating unit 250 or the transparent conductive film member 250 is in contact with the touch panel 122 according to the touch on the auxiliary output unit 240, and the controller 170 controls the auxiliary output unit 240 to output the data or contents according to the signal value recognized by the touch panel 122.

The cover member 220 is pivotally coupled to the rear cover 210, and covers the input/output unit 120 of the body 110 so that it opens and closes the input/output unit 120 on the front surface of the body 110. In the present invention, the cover member 220 will be described by roughly classifying it into three embodiments according to its configuration or shape. The cover member 220 according to the first and second embodiments includes the auxiliary output unit 240 and the electrostatic capacitance generating unit 250, and the cover member 220 according to the third embodiment includes the auxiliary output unit 240 and the transparent conductive film member 250.

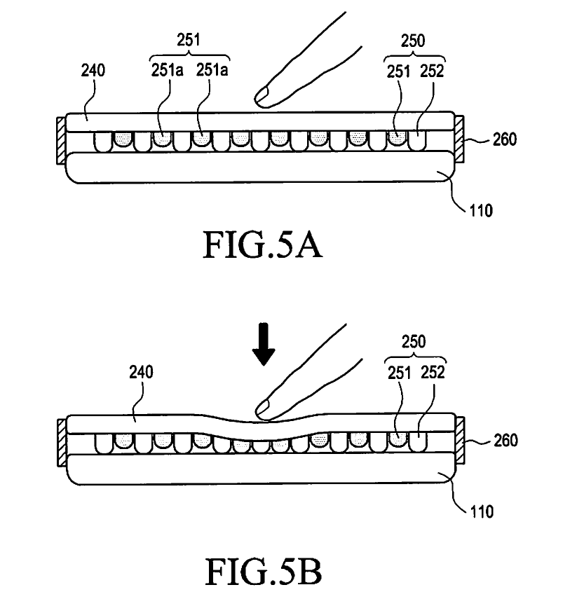

FIG. 5 is a sectional view illustrating the portable terminal shown in FIG. 3 according to the first embodiment of the present invention, in which the portable terminal has a cover member 220. Referring to FIG. 5, the cover member 220 according to the first embodiment of the present invention includes the auxiliary output unit 240 and the electrostatic capacitance generating unit 250.

The auxiliary output unit 240 is provided on a front surface of the cover member 220 and is exposed to the outside when the cover member 220 is covering the input/output unit 120, so as to output the predetermined data or contents similarly to the display panel 121 of the body 110.

It is described as an example that the auxiliary output unit 240 of the present invention has a size substantially the same as or identical to that of the input/output unit 120 of the body 110 and is provided at the same position as that of the input/output unit 120 and faces the input/output unit 120 to overlay the input/output unit 120. Accordingly, the touch panel 122 recognizes that a touch on the auxiliary output unit 240 is a touch on the display panel 121 located at the same position. As if the touch panel 122 recognizes a touch on a predetermined position of the display panel 121 when the touch occurs on the predetermined position of the display panel 121 in the state where the cover member 220 is open (see FIG. 3A), the touch panel can detect a touch on a predetermined position of the auxiliary output unit 240 as a touch on a predetermined position of the display panel 121 when the touch occurs on the predetermined position of the auxiliary output unit 240 (herein, the ‘predetermined position’ refers to a position corresponding to the position of the touch on the display panel 121) when the cover member 220 covers the input/output unit 120 (see FIG. 3B).

In the device 10 according to the present invention, accordingly, in the state where the cover member 220 is open, the touch panel 122 detects the touch on the display panel 121 and enables the display panel 121 to display the predetermined data or contents. In the state where the cover member 220 is closed, the touch panel 122 detects the touch on the auxiliary output unit 240 through the electrostatic capacitance generating unit 250 opposite to the auxiliary output unit 240 and enables the auxiliary output unit 240 to display the predetermined data or the contents according to the touch on the auxiliary output unit 240. As described above, accordingly, as the auxiliary output unit 240 and the display panel 121 have the same size and are arranged to be opposite to each other, touch signals applied to the touch panel 122 occurs at corresponding positions of the opposite auxiliary output unit 240 and display panel 121. In the case of separately setting an output according to a signal value set to the touch panel 120 which recognizes a touch on the auxiliary output unit 240, however, as described above, the auxiliary output unit 240 need not have the same size as that of the input/output unit 120 and also the auxiliary output unit 240 need not be disposed at the same position as that of the input/output unit 120. However, since the touch on the auxiliary output unit 240 has to be applied to the touch panel 120, the auxiliary output unit 240 is preferably disposed within a frame of the touch panel 120 so that the touch panel 120 recognizes the touch. As described above, since the auxiliary output unit 240 has the same size as that of the input/output unit 120 of the body 110 and is disposed to be opposite to the input/output unit 120, an input to the touch panel or an output from the auxiliary output unit 240 according to the input can be implemented in the same manner as the output unit of the body 110.

The cover member 220, particularly the auxiliary output unit 240, is made of a transparent flexible film or plastic. Accordingly, when a touch occurs at a specific position of the cover member 220, a touch position is pushed while the electrostatic capacitance generating unit 250 provided at the touch position reacts to the touch panel 122, so that data according to the pushed position can be executed. Such an auxiliary output unit 240 basically is not configured to detect an input according to the touch, and the touch panel 122 detects the input through the electrostatic capacitance generating unit 250 described above. The auxiliary output unit 240 is a device 10 which outputs the contents or data set according to the signal value generated from the touch panel 122 such as the display panel 121 provided to the body 110. For example, the auxiliary output unit 240 implements an output of a predetermined content such as time, date, receiving or sending a call, receiving or sending a message, a display related to an application, and the like, similarly to the display panel 121.

As seen in FIGS. 5A and 5B, the electrostatic capacitance generating unit 250 of the present invention is provided on a rear surface of the cover member 220, particularly a rear surface of the auxiliary output unit 240. The electrostatic capacitance generating unit 250 includes an electrostatic pattern portion 251 and an elastic portion 252. The electrostatic pattern portion 251 is provided on a surface of the cover member 220, particularly a surface opposite to a surface of the input/output unit 120 when the cover member 220 is folded on the input/output unit 120, and is spaced at a predetermined distance from the touch panel 122. The electrostatic pattern portion 251 has a plurality of electrostatic patterns 251a which are divided into a plurality of regions corresponding to a size of the touch panel and formed to be adjacent to one another on the surface of the cover member 220. The electrostatic patterns 251a may be disposed in the form of a predetermined grid. Further, since the divided regions of the electrostatic patterns 251a are increased in order to improve a touch resolution according to a touch on the auxiliary output unit 240, shapes or structures of the electrostatic patterns 251a may be changed and modified according to a required touch resolution or necessity. The electrostatic patterns 251a are preferably made of electric charges so that electrostatic capacitance of the touch panel 122 is varied at a contact point when each electrostatic pattern 251a contacts the touch panel 122 at its contact point. For example, the electrostatic patterns 251a are made of a synthetic plastic, a synthetic metal, an electrostatic medium and the like on a surface of the input/output unit 120.

The elastic portions 252 are disposed between the electrostatic patterns 251a respectively, and support the cover member 220 so that the electrostatic patterns 251a are spaced at a predetermined distance from the touch panel 122. Accordingly, in the state where the cover member 220 is folded on the input/output unit 120, the elastic portions 252 are in contact with the input/output unit 120, and the electrostatic patterns 251a are spaced at the predetermined distance from the touch panel 122 to not be in contact with the touch panel 122. In this state, when a touch occurs on a surface of the cover member 220, particularly the auxiliary output unit 240, the auxiliary output unit 240, at a position where the touch occurs, is pressed to the touch panel 122 by the touch because it is flexible. The elastic portions 252 are also pressed at a position where the touch occurs, and the electrostatic patterns 251a spaced from the touch panel 122 contact a surface of the touch panel 122 as the elastic portions 252 are pressed. The elastic portion 252 may be made of an elastic material such as rubber, silicon, an elastic plastic, and the like.

As the auxiliary output unit 240 is pressed at a predetermined position thereof, the electrostatic patterns 251a at that position are in contact with the input/output unit 120, particularly the touch panel 122, at the position where the touch occurs. Then, the touch panel 122 reacts to the electrostatic pattern 251a at a position corresponding to the position where the touch occurs, so as to vary the electrostatic capacitance. The controller 170 executes a menu or a predetermined data corresponding to the touch position according to a variation value of the electrostatic capacitance generated at a predetermined position of the touch panel 122. Further, the menu or the predetermined data executed according to recognition of the touch panel 122 is output through the auxiliary output unit 240.

As described above, the auxiliary output unit 240 and the display panel 121 have a similar function in which an output is implemented when the touch occurs, and the touch panel 122 recognizes the touch on the auxiliary output unit 240 through the electrostatic capacitance generating unit 250 in the same manner that the touch panel 122 recognizes a touch on the display panel 121. According to the embodiment of the present invention, further, the touch panel 122 recognizes an input according to the touch on the auxiliary output unit 240 through a structure in which the cover member 220 is provided with the electrostatic patterns 251a and the elastic portions 252.

Accordingly, the device of the present invention allows both an input and an output in either case of the cover member 220 being open or covered. Particularly, when the cover member 220 is closed, the auxiliary output unit 240 and the electrostatic capacitance generating unit 250 provided on the cover member 220, along with the touch panel 122 of the body 110 operate together, resulting in an implementation of the input and output. When the cover member 220 is open, the display panel 121 and the touch panel 122 of the body 110 operate, resulting in the implementation of the input and output.

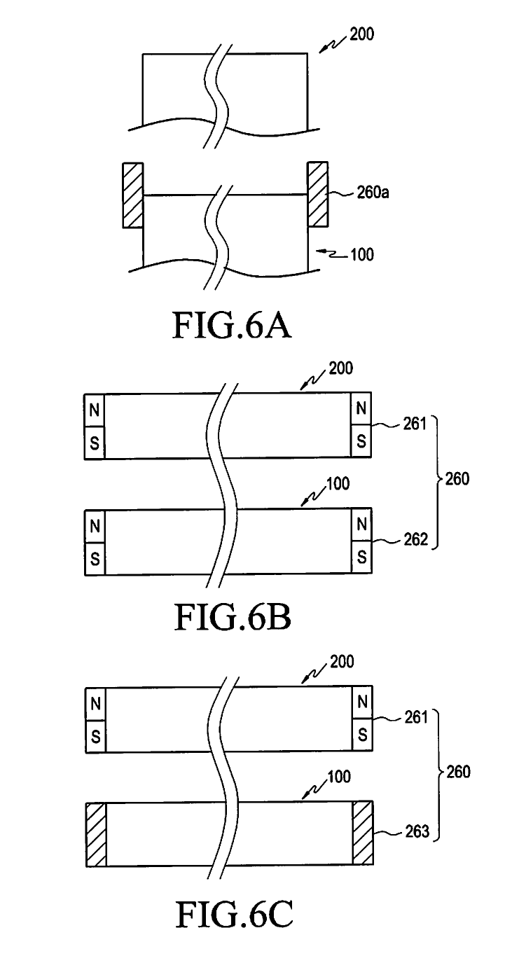

FIGS. 6A-6C are views illustrating examples of a fixed guide member of the portable terminal shown in FIG. 5 according to the embodiment of the present invention. Referring to FIG. 6A, when the cover member 220 is folded on the body 110, the auxiliary output unit 240, particularly the electrostatic capacitance generating unit 250, is disposed at a position corresponding to a position of the input/output unit 120. The cover member 220 is fixed to the body by means of fixed guide members 260 in order to restrict a separation of the cover member 220 from the body 110. As described above, the auxiliary output unit 240 has the same size as that of the input/output unit 120, particularly the touch panel 122 which is an input unit, and is arranged on the touch panel 122 to be opposite to the touch panel 122. In order to secure the arrangement of the input unit and the touch panel 122, the fixed guide member 260 is provided. In the device 10 according to the embodiment of the present invention, the cover member 220 is configured to cover the body 110, and the fixed guide member 260 is configured to be seated on a periphery of the body 110. However, the position of fixed guide member 260 according to the embodiment of the present invention may be changed and modified if it fixes the auxiliary output unit 240 and the electrostatic capacitance generating unit 250 to the touch panel 122.

The fixed guide member 260 can be classified into three types. In FIG. 6A, a fixed guide member 260 according to a first embodiment is provided with one or more side protrusions 260a along the periphery of the portable terminal 100. That the side protrusions 260 of the present invention protrude on a side periphery of the body 110 is merely an example. Accordingly, when the cover member 220 is folded on the front surface of the body 110, a side periphery of the cover member 220 is seated in and fixed to the side protrusion 260. The cover member 220 may be placed at the same position where the fixed guide member 260, the auxiliary output unit 240 and the touch panel 122 are arranged. Since the auxiliary output unit 240 and the electrostatic capacitance generating unit 250 are arranged to be opposite to the touch panel 122, and fixed to the touch panel 122, an input can be implemented at an accurate position of the touch panel 122 through the auxiliary output unit 240 and the electrostatic capacitance generating unit 250.

Although not shown in the drawings, in one embodiment of the present invention, since the cover member 220 is pivotally coupled with the body 110 at a side thereof through connection member 230 (see FIG. 1), the fixed guide member 260 may be provided to another side of the cover member 220 opposite to the side of the cover member 220 where connection member 230 is located, or may be provided on an upper surface or a lower surface of the cover member 220, or the upper surface and the lower surface of the cover member 220. That is, if the fixed guide member 260 according to the embodiment of the present invention is provided at the same position as those of the touch panel 122 and the cover member 220, particularly the electrostatic capacitance generating unit 250, the fixed guide member 260 may be changed and modified by any amount.

As seen in FIG. 6B, a fixed guide member 260 according to a second embodiment includes a first magnetic member 262 and a second magnetic member 261. The first magnetic member 262 is provided on a side periphery of the portable terminal 100, particularly the body 110, and the second magnetic member 261 is provided on a side periphery of the cover unit 200, particularly the cover member 220. Further, the first magnetic member 262 and the second magnetic member 261 are placed to be opposite to each other, so as to generate an attraction. Accordingly, when the cover member 220 is folded on a front surface of the body 110, the first magnetic member 262 is associated with the second magnetic member 261 so that the auxiliary output unit 240 and the electrostatic capacitance generating unit 250 are fixed to the touch panel 122. Accordingly, a touch can be accurately input to the touch panel 122 through the auxiliary output unit 240 and the electrostatic capacitance generating unit 250.

As seen in FIG. 6C, a fixed guide member 260 according to a third embodiment includes a magnetic member 261 and a magnetic material 263 associated with the magnetic member 261. That is, the magnetic member 261 is provided on a side periphery of one of the body 110 and the cover unit 200, particularly the cover member 220. The magnetic material 263 associated with the magnetic member 261 is provided on a side periphery of a remaining one of the body 110 and the cover member 220. Therefore, the magnetic member 261 and the magnetic material 263 are coupled with each other by a magnetic force, so as to fix the cover member 220 to an upper surface of the body 110, particularly to fix the auxiliary output unit 240 and the electrostatic capacitance generating unit 250 to the touch panel 122 to be opposite to each other, resulting in the prevention of movement of the cover member 220. Accordingly, a touch through the auxiliary output unit 240 and the electrostatic capacitance generating unit 250 can be accurately recognized by the touch panel 122.

As the auxiliary output unit 240 is fixed to the touch panel 122 by using the fixed guide member 260 according to the embodiments described above, the auxiliary output unit 240 performs the same function as that of the input/output unit 120 of the body 110, i.e., the display panel 121. For example, when a menu or a specific application output through the auxiliary output unit 240 is touched, the electrostatic capacitance generating unit 250 provided at a position of the specific application contacts the touch panel 122. The controller 170 executes the predetermined data, e.g., the specific application, according to a place at a touch position according to a touch signal, and when the specific application is executed, the auxiliary output unit 240 is controlled to display an output corresponding to the application. Accordingly, although a separate structure such as the touch panel 122 provided to the body 110 is not provided to the cover member 220 in order to implement an input, the input and output can be implemented through the auxiliary output unit 240 and the electrostatic capacitance generating unit 250 by using the touch panel 122 provided to the body 110.

As described above, in the present invention, the cover unit 200 is provided in the form of a flip cover of which the cover member 220 is rotatably coupled to the body 110 and folded on the front surface of the body 110. Therefore, the cover unit 200 further includes a rear cover 210 and a connection member 230 as well as the cover member (see FIG. 1).

The connection member 230 is an element for rotatably coupling the cover member 230 with the rear cover 210. The connection member 230 forms a hinge structure. However, in the present invention, this is merely an example that the connection member 230 is connected to the cover member 220 made of a soft material.

The rear cover 210 is detachably provided on the rear surface of the body 110, and covers the rear surface of the body 110. The flip cover of the present invention can be classified into two types according to the shape of the rear cover 210. One flip cover is integrated with the body 110 in one piece, and the other flip cover is formed separately from the body 110 and detachably attached to the body 110. Here, the term “one piece” refers to a structure in that the cover unit 200, particularly, the rear cover 210 of the cover unit 200, is provided to the body 110 so that the body 110 becomes a complete structure in which the cover unit 200 is integrated with the body 110 so as to establish the body as a finished product. That is, if the rear cover 210 is not integrated with the body 110, the body cannot be a complete structure. Therefore, the ‘rear cover 210’ is integrated with a body 110 in one piece. In other words, the cover unit 200, particularly, the rear cover 210, is disclosed as a structural element of the body 110, which means that the rear cover 210 functions as one structural element of the body 110. Further, the term “separate” means that the rear cover 210 is not one structural element integrated with the body 110 as a finished product, but is a separate structural element with only the body 110 being a complete structure although the cover unit 200 is not provided to the body 110. In other words, the cover unit 200 is a separate structural element which is coupled to the complete structure of the body 110.

Although not shown in the drawings, the body 110 has a space for mounting of a battery in a rear portion, and has a rear bracket coupled to the rear portion thereof As described above, when the rear cover 210 is integrated with the body 110 in one piece, the rear cover 210 is detachably attached to the body 110 to cover the rear bracket of the body 110 and functions as a structure of the body 110, i.e., a rear case. In this case, the portable terminal 100 may have a thickness which is thinner than that of the portable terminal 100 in which the cover unit 200 is separately provided to the body 110, and provides a high-quality and beautiful appearance in view of a design. The cover member 220 rotates around the rear cover 210 integrated with the body 110 by the connection member 230 in one piece so as to open and close the input/output unit 120.

When the rear cover 210 is provided separately from the body 110, the rear case covering the rear bracket is integrated with the body 110 in one piece. In this state, the rear cover 210 is detachably attached to the rear surface of the body 110. That is, the rear cover 210 covers the rear case and is detachably attached to the rear surface of the body 110. The cover member 220 rotates around the rear cover 210 separately provided to the body 110 so as to open and close the input/output unit 120.

As described above, in the present invention, the cover unit 200 is a flip type cover. It is described as an example that the cover unit 200 includes the cover member 220, the connection member 230 and the rear cover 210, but the cover unit 200 is not limited thereto. That is, if the cover member 220 is provided to protect an upper surface of the input/output unit 120 of the body 110 and has an electrostatic capacitance generating unit 250 or a transparent conductive film member 250 capable of transmitting a touch on an auxiliary output unit 240 opposite to the input/output unit 120 to a touch panel 122, the cover unit 200 may be provided with only the cover member 220.

The device 10 according to one embodiment of the present invention constructed as described above is provided with the auxiliary output unit 240 and the electrostatic capacitance generating unit 250 capable of varying the electrostatic capacitance in the touch panel 122 on a rear surface of with the cover member 220, so that an input and output can be performed although the cover unit 200 is not open. Further, the input can be performed by using only a simple structure of the electrostatic patterns 251a and the elastic portion 252 in the state that the cover unit 200 is closed, similarly to the input performed by using the conventional touch panel 122. Thereby, it is possible to reduce costs. Further, although the electrostatic capacitance generating unit 250 has no separate electric power source, the electrostatic capacitance generating unit 250 can vary the electrostatic capacitance through the touch on the touch panel 122. Accordingly, it is possible to reduce a consumption of electric power. Furthermore, if external impact is applied to the cover member 220, the elastic portion 252 can reduce an amount of impact force applied to the input/output unit 120 and protect the input/output unit 120.

Hereinafter, another embodiment (second embodiment) of the electrostatic capacitance unit 250 among the structural elements described above will be described. Further, with relation to the description of the second embodiment of the present invention, the previous description will be applied to the description of the same structure as those of the embodiment described above, and a difference between the structure of the first embodiment and the structure of the second embodiment will be described.

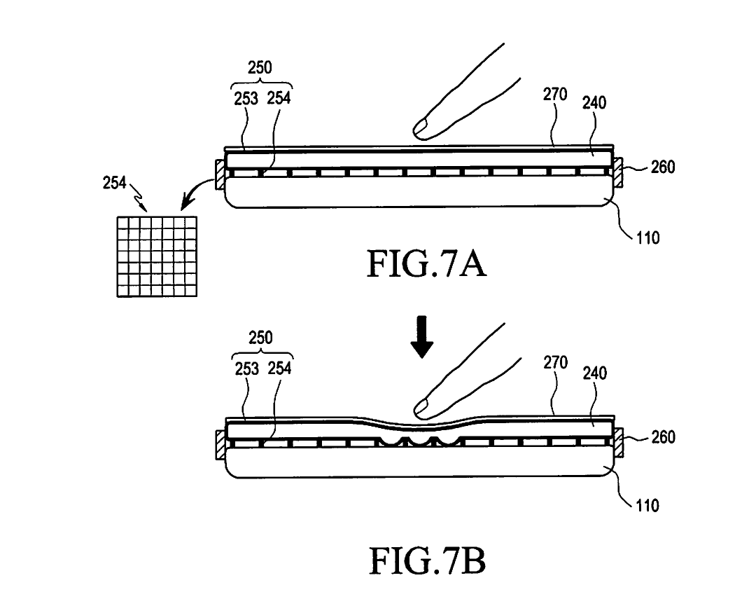

FIGS. 7A and 7B are sectional views illustrating the portable terminal shown in FIG. 1, in which another example of the cover member, particularly, an electrostatic capacitance generating unit, is provided to the portable terminal. Referring to FIGS. 7A and 7B, a difference between the device 10 according to the embodiment of FIG. 7 and the device 10 described above is a structure of the electrostatic capacitance generating unit 250. The device 10 of FIG. 7 has the same structure as that of the device of the embodiment described above, except for a structure of the electrostatic capacitance generating unit 250. That is, the electrostatic capacitance generating unit 250 of the embodiment described above has a structure in that the electrostatic pattern portion 251 and the elastic portion 252 are formed on the auxiliary output unit 240, but the electrostatic capacitance generating unit 250 according to the embodiment as shown in FIG. 7 has a structure that includes an electrostatic coating layer 253 and a supporting portion 254. First, the cover member 220 and/or the auxiliary output unit 240 are made of a transparent elastic material with an excellent elasticity, similar to the embodiment described above. Accordingly, the electrostatic coating layer 253 is deformable so as to contact the touch panel 122 between the supporting portions 253 described below by a pressure applied to the auxiliary output unit 240.

The electrostatic coating layer 253 is formed by coating an electrostatic capacitance generating substance on a whole surface of the cover member 220 or the auxiliary output unit 240, and recognizes a touch of an object having an electric charge such as a user's hand on the auxiliary output unit 240. Here, the term “coating” generally means that a film made from an electrostatic capacitance generating substance is covered on or attached to the cover member 220 or the auxiliary output unit 240, or that the electrostatic capacitance generating substance is coated on a whole surface of the cover member 220 or the auxiliary output unit 220 so as to form a thin coating layer. In the present embodiment, it will be described below that the electrostatic coating layer 253 is provided on a whole surface of the auxiliary output unit 240, and the auxiliary output unit 240 is arranged to be above and face the input/output unit 120. As shown in FIG. 2, the auxiliary output unit 240 is provided to a whole surface of the cover member 220 and the cover member 220 is folded on the front surface of the body 110 provided with the input/output unit 120. Accordingly, the electrostatic coating layer 253 is coated on a whole surface of the cover member 220, and the electrostatic coating layer 253 is folded on to face the input/output unit 120. For example, as schematically shown in FIG. 7, if the auxiliary output unit 240 is provided to face the input/output unit 120, the electrostatic coating layer 253 is provided on the whole surface of the auxiliary output unit 240. As shown in FIG. 1, if the cover member 220 is provided to face the input/output unit 120, the electrostatic coating layer 120 may be provided on the whole surface of the cover member 220.

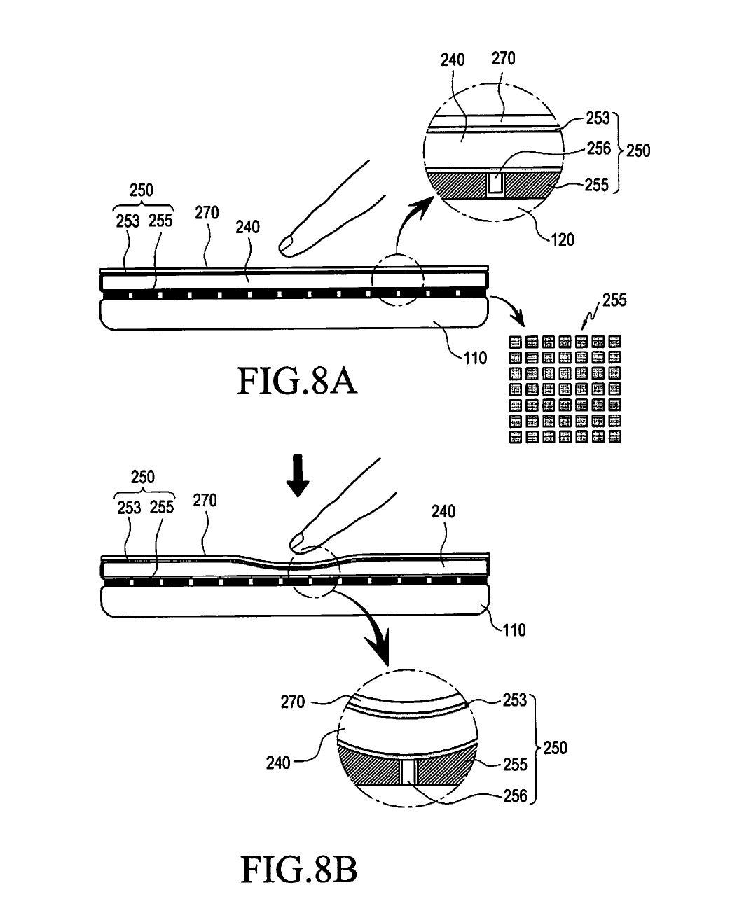

The supporting portion 254 is disposed on a surface of the cover member 220 folded on the input/output unit 120, particularly on a surface of the auxiliary output unit 240, and has a predetermined pattern, e.g., a mesh pattern in the present embodiment. The supporting portion 254 has a mesh pattern with a line shape (another type of supporting portion 255 has a surface shaped mesh pattern, and will be described later with regards to FIG. 8). Therefore, a surface of the cover member 220 opposite to the input/output unit 120 (a surface of an auxiliary output unit 240 in the present embodiment) is supported by the supporting portion 254 and spaced at a predetermined distance. Further, the supporting portion 254 is formed in a mesh shaped pattern, and the electrostatic coating layer 253 is partitioned constantly between the supporting portion 254 and the neighboring supporting portion 254 on a surface of the cover member 220. Accordingly, when a touch on the cover member 220, particularly, the auxiliary output unit 240, occurs, the cover member 220 is elastically pressed at a touch position because the cover member 220 is made of an elastic material and an electrostatic coating layer 253 coated on the auxiliary output unit 240 is in contact with the input/output unit 120, particularly, the touch panel 122, at the touch position in the electrostatic coating layer 253 which is supported by the supporting portion 254 and the neighboring supporting portion 254. As the electrostatic coating layer 253 is in contact with the touch panel 122, an input may be implemented. Accordingly, when an object such as a hand touches the auxiliary output unit 240, the electrostatic coating layer 253 is elastically pressed to the touch panel 122 at a touch position around the supporting portion 254. Further, since a remaining portion of the cover member 220 is spaced at a distance from the input/output unit 120 by the supporting portion 254, the electrostatic coating layer 253 is in contact with the input/output unit 120, particularly, the touch panel 122, at a position where which the cover member 220 is pressed by a touch and an input can be implemented at a position where the electrostatic coating layer 253 is in contact with the touch panel 122.

A conductive protective film 270 is attached on another surface of the cover member 220, i.e., a front surface of the auxiliary output unit 240 (a surface exposed to the outside), so as to protect the auxiliary output unit 240 on which the electrostatic coating layer 253 is formed. The conductive protective film 270 is made of a transparent flexible material with elasticity, and is elastically pressed at a position where the touch occurs.

An input operation implemented in the device 10 having the structure of FIG. 7 will be described.

A state of the device 100 when the sensor unit 130 detects a signal will be described. The cover member 220, e.g., the auxiliary output unit 240, having an electrostatic coating layer 253 on its whole surface, is folded on the input/output unit 120 of the body 110. Since the electrostatic coating layer 253 opposite to a surface of the cover member 220 is spaced at a predetermined distance from the input/output unit 120 by the supporting portion 254, the auxiliary output unit 240 is in noncontact with the input/output unit 120. Further, in the state that the cover member 220, is folded on a front surface of the body 110, the body 110 stays in a sleep mode to operate at any time. Accordingly, although it appears that the body 110 is turned off as if it is not used, the auxiliary output unit 240 and the touch panel 122 of the body 110 are supplied with electricity and turned on.

The auxiliary output unit 240 supplied with the electricity has an identical screen to that of the display panel 121, or separately displays a predetermined content. This may be changed by the controller 170 according to a predetermined value. For example, the auxiliary output unit 240 may output a simple content such as a time and weather, and the display panel 121 may output icons for predetermined content such as an execution of an application using a social network, and receiving and sending a call or a message.

Further, when a touch of the object such as a hand on the auxiliary output unit 240 occurs in the state that the sensor unit 130 detects a signal, as described above, the auxiliary output unit 240 is pressed to the input/output unit 120 at a touch position, and other portions of the auxiliary output unit 240 except for the touch position of the auxiliary output unit 240 are supported by the supporting portion 254 and spaced at a predetermined distance from the input/output unit 120. That is, although the electrostatic coating layer 253 is coated on the whole surface of the cover member 220, remaining portions of the electrostatic coating layer 253 other than a portion contacting the touch panel 122 are in noncontact with the touch panel 122 by the supporting portion 254. Accordingly, an input is not implemented at portions other than the portion pressed and contacting the touch panel 122 by the touch. The electrostatic coating layer 253 of the auxiliary output unit 240 is pressed and is in contact with the touch panel 122 by the elasticity. Thus, as electrostatic capacitance is varied at a contact portion of the touch panel contacting the electrostatic coating layer, the touch panel detects a touch.

On the other hand, when the cover member 220 rotates away from the front surface of the body 110, a signal detected by the sensor unit 130 is interrupted. Further, as the cover member 220 rotates away from the front surface of the body 110, the input/output unit 120 is exposed to the outside. Thus, the controller 170 interrupts a supply of electricity to the cover member 220, and controls to activate the body 110. That is, electricity supplied to the cover member 220, particularly, electricity supplied to the auxiliary output unit 240, is interrupted so that an input and an output through the auxiliary output unit 240 and the electrostatic capacitance generating unit 250 are turned off, and the cover member 220 is deactivated. Further, the input/output unit 120 provided to the body 110 is turned on, so as to activate the body 110. Accordingly, when an output is implemented on the display panel 121, a touch panel 122 detects a touch on the display panel 121, and outputs the predetermined contents through a display panel 121 according to the detected signal.

Hereinafter, another embodiment of the electrostatic generating unit 250, particularly, the supporting portion of the structure described above, will be described. Further, with relation to the description of the second embodiment of the present invention, the previous description will be applied to the description of the same structures as those of the embodiment described above, and a difference between the structure of the first embodiment and the structure of the second embodiment will be described.

FIGS. 8A and 8B are sectional views illustrating the portable terminal shown in FIG. 7, in which another example of the electrostatic capacitance generating unit, particularly, a supporting portion, is provided to the portable terminal. Referring to FIG. 8, a difference between the device 10 according to the embodiment of FIG. 8 and the device 10 according to the embodiment of FIG. 7 is the structure of the electrostatic capacitance generating unit 250. In the embodiment of the present embodiment, the electrostatic capacitance generating unit 250 includes an electrostatic coating layer 253 and the supporting portion 255, and further includes a transfer unit 256 according to a structure of the supporting portion 255.

Particularly, the electrostatic capacitance generating unit 250 according to the present embodiment includes an electrostatic coating layer 253, a supporting portion 255 and a transfer portion 256. The electrostatic coating layer 253 is formed in which an electrostatic capacitance generating substance is coated on a whole surface of a flexible cover member 220 and/or the auxiliary output unit 240 as described above in the second embodiment. Thus, the electrostatic coating layer is configured to vary electrostatic capacitance of the touch panel when the electrostatic coating layer is in contact with the touch panel.

The supporting portion 255 according to the present embodiment is disposed on a surface of the cover member 220 folded on the input/output unit 120, particularly, on a surface of the auxiliary output unit 240, and has a predetermined pattern, e.g., a mesh shaped pattern in the present disclosure. However, the mesh shaped pattern of the supporting portion 255 of the present embodiment has a difference with the mesh shaped pattern of the supporting portion 254 of the second embodiment.

That is, the mesh shaped pattern of the supporting portion 254 in the second embodiment has a line shape, but the mesh shaped pattern of the supporting portion 255 according to the present embodiment has a surface shape. Further, a transfer portion 256 is provided between the patterns of the surface shaped supporting portion 255. The transfer portion 256 may be made of the same material as the electrostatic coating layer 253, and may vary the electrostatic capacitance of the touch panel 122 when it is in contact with the touch panel 122. Accordingly, the supporting portion 254 has the line shaped mesh pattern in the second embodiment, while the transfer portion 256 has the line shaped mesh pattern in the present embodiment.

The auxiliary output unit 240 is pressed at a touch position by a touch on the cover member 220, constructed as described above. Thus, the cover member 220 which is flexible and elastic is elastically pressed at a touch position, and a transfer portion 256 is in contact with the input/output unit 120 at the touch position. Therefore, the transfer portion 256 varies electrostatic capacitance of the touch panel 122 and the touch panel 122 detects the touch. Further, since the remaining portion of the transfer portion 256 other than the touch portion is spaced at a predetermined distance from the input/output unit 120, the touch panel 122 can detect the touch on the auxiliary output unit 240 at the touch position.

A flexible and conductive protective film is attached on another surface of the cover member 220, i.e., a front surface of the auxiliary output unit 240 (a surface exposed to the outside), so as to protect the auxiliary output unit 240 on which the electrostatic coating layer 253 is formed.

An input operation implemented in the device 10 having the above structure will be described.

A state of the device 100 when the sensor unit 130 detects a signal will be described. The cover member 220, e.g., the auxiliary output unit 240, having an electrostatic coating layer 253 on its whole surface, is folded on the input/output unit 120 of the body 110. The electrostatic coating layer 253 on the surface of the cover member 220 is exposed to the outside, and a transfer portion 256 provided on the remaining surface of the cover member 220 is coupled with the electrostatic coating layer 253 between the neighboring support portions 255. The transfer portion 256 is spaced at a predetermined distance from the input/output unit 120 by the supporting portion 255, and is in noncontact with the input/output unit 120 (see FIG. 8A). When the sensor unit 130 detects a signal, the controller 170 controls to supply electricity to and turns on the auxiliary output unit 240 and the touch panel 122 of the body 110. The auxiliary output unit 240 supplied with the electricity has an identical screen to that of the display panel 121, or separately displays a predetermined content. As described above as an example in the previous embodiments, this may be changed by the controller 170 according to the predetermined contents. In the state that the sensor unit 130 detects a signal, when an object such as a hand with an electric charge is touched on the auxiliary output unit 240 (see FIG. 8B), as described above, electric charges are generated on the electrostatic coating layer 253 and the auxiliary output unit 240 is elastically pushed at a touch position in the state that it is supported by the supporting portion 255. Thus, the transfer portion 256 is in contact with the input/output unit 120 at the touch position. As the transfer portion 256 is in contact with the touch panel 122 at a touch position, the touch panel 122 detects a contact of the transfer portion 256. A contact signal detected by the touch panel 122 is applied to the controller 170, and the controller 170 controls to output data which is set depending on a contact detection value of the touch panel 122 through the auxiliary output unit 240. Further, although the electrostatic coating layer 253 is coated on the whole surface of the cover member 220, other portions, other than a portion that the object such as the hand touches and presses, do not contact the transfer portion 256 and the touch panel 122 by means of the supporting portion 255. Thus, an input at the positions other than the touch position is not implemented.

On the other hand, when the cover member 220 rotates away from the front surface of the body 110, a signal detected by the sensor unit 130 is interrupted. Further, as the cover member 220 rotates away from the front surface of the body 110, the input/output unit 120 is exposed to the outside. Therefore, the controller 170 controls to turn off the cover unit 200, particularly, the auxiliary output unit 240, and electricity is supplied to and activates the body 110. That is, electricity supplied to the cover member 220, particularly, electricity supplied to the auxiliary output unit 240, is interrupted so that an input and an output through the auxiliary output unit 240 and the electrostatic capacitance generating unit 250 are turned off, and the cover member 220 is deactivated. Further, the input/output unit 120 provided on the body 110 is turned on, so as to activate the body 110. Accordingly, when an output is implemented on the display panel 121, a touch panel 122 detects a touch on the display panel 121, and outputs the predetermined contents through the display panel 121 according to the detected signal.

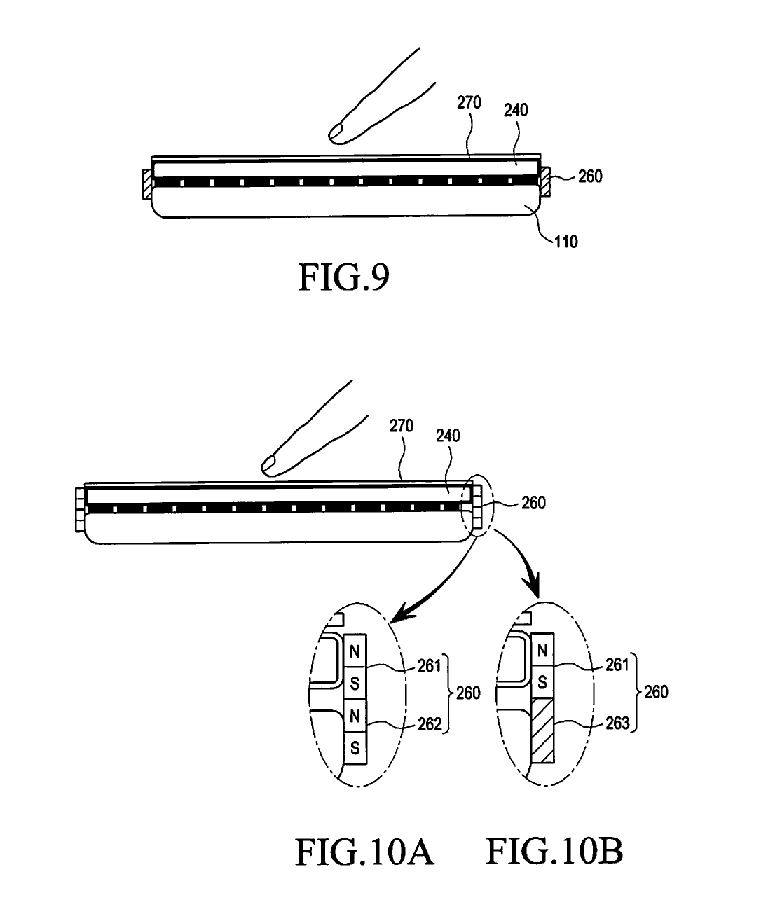

FIG. 9 is a sectional view illustrating a portable terminal shown in FIG. 8, in which the fixed guide member is provided to the portable terminal, and FIGS. 10A and 10B are sectional views illustrating a portable terminal shown in FIG. 9, in which the fixed guide member according to another embodiment is provided to the portable terminal. Referring to FIGS. 9 and 10, in the device according to the second embodiment of the present invention, a fixed guide member 260 is provided for fixing the cover member 220 to the body 110 so that the auxiliary output unit 240 and the electrostatic capacitance generating unit 250 are opposite to the touch panel 122, and maintains the fixed state of the cover member 220 and the body 110. Further, as described above, the fixed guide member 260 has a protruding shape (see FIG. 9), a first magnetic member 262 and a second magnetic member 261 (see FIG. 10A), or a magnetic member 261 and a magnetic material 263 associated with the magnetic member 261 (SEE FIG. 10B). The detailed contents refer to the above-mentioned contents.

In the device 10 according to one embodiment of the present invention as described above, the electrostatic coating layer 253 is coated on the whole surface of the cover member 220, particularly, an auxiliary output unit 240, so that a transfer portion 256 connected to the electrostatic coating layer 253 or the electrostatic coating layer 253 varies electrostatic capacitance of the touch panel when a touch on the auxiliary output unit 240 occurs. Accordingly, it is possible to perform an input and an output although the cover unit 200 is not open. Further, although the electrostatic capacitance generating unit 250 has no separate electric power source, the electrostatic capacitance generating unit 250 can vary the electrostatic capacitance through the touch on the touch panel 122. Accordingly, it is possible to reduce a consumption of electric power. Further, when the supporting portion 254 has a more fine mesh shape, the touch resolution of the auxiliary output unit 240 can be improved. Further, the input using the conventional touch panel 122 can be implemented by using only a simple structure in that the electrostatic coating layer 253 and the supporting portion 254 is provided to the cover member 220 in the state that the cover unit 200 is closed. Thereby, it is possible to reduce a cost. Furthermore, if an external impact is applied to the cover member 220, the elastic portion 252 can reduce an amount of impact force applied to the input/output unit 120 and protect the input/output unit 120.

Hereinafter, another embodiment (third embodiment) of the electrostatic capacitance unit 250 among the structural elements described above will be described. Further, with relation to the description of the third embodiment of the present invention, the previous description will be applied to the description of the same structures as those of the embodiment described above, and a difference between the structure of the embodiments will be described.

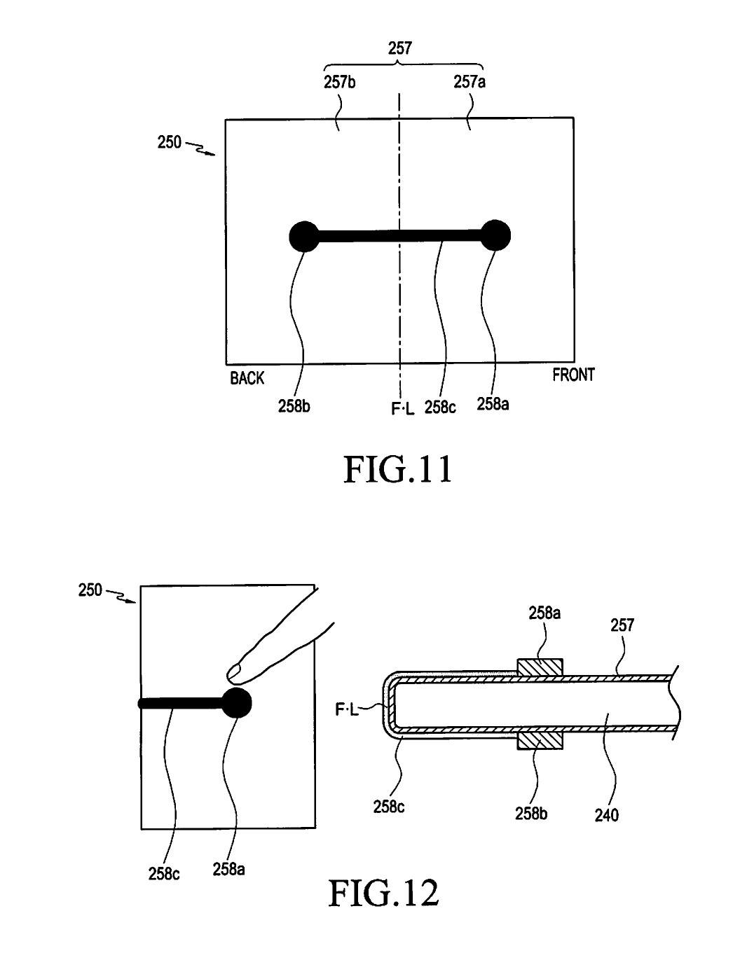

FIG. 11 is a view schematically illustrating a transparent conductive film member provided to the cover member shown in FIG. 1, and FIG. 12 is a view schematically illustrating the cover member provided with the transparent conductive film member shown in FIG. 11. Referring to FIGS. 11 and 12, the device 10 according to the third embodiment of the present invention has a difference in a structure of the electrostatic capacitance generating unit 250 from the device according to the first and second embodiments of the present invention. That is, the device 10 of the present embodiment includes a body 110, a cover member 220 and a transparent conductive film member 250.

The body 110 and the cover member 220 are identical to those of the other embodiments as described above, and the description of the body 110 and the cover member 220 refers to the above descriptions. The transparent conductive film member 250 of the present embodiment is provided on front and rear surfaces of the cover member 220, particularly, the front and rear surfaces of the auxiliary output unit 240 at opposite positions.

The transparent conductive film member 250 includes a transparent film portion 257 and a contact pattern 258. The transparent film portion 257 is folded to bisect the transparent film member 250, and is attached to front and rear surfaces of the auxiliary output unit 240. The transparent film portion 257 includes a front transparent film 257a provided on a front surface of the cover member 220, particularly, a front surface of the auxiliary output unit 240, around a folding line F.L., and a rear transparent film 257b folded from the front transparent film 257a along the folding line F.L. and provided on a rear surface of the auxiliary output unit 240.

The contact pattern 258 is provided on the transparent film portion 257 such as polypropylene by printing, and generates electrostatic capacitance according to a touch of an object such as a hand thereon. An ITO pattern will be described as an example of the contact pattern 258.

Further, the contact patterns 258 of the present invention are provided to be opposite to each other on the front transparent film 257a and the rear transparent film 257b around the folding line F.L. of the transparent film portion 257 like a decal. Particularly, the contact pattern 258 includes a front pattern 258a and a rear pattern 258b, which are connected to each other by a connection line 258c and are arranged to be opposite to each other in a folding state. That is, the front pattern 258a and the rear pattern 258b which are connected to each other by the connection line 258c are arranged to be opposite to each other at the same position in the state that transparent film portion 257 is folded around a folding line F.L. Accordingly, when the transparent film portion 257 is folded around the folding line F.L., the front pattern 258a and the rear pattern 258b arranged to be opposite to each other at the same position. When the object such as the hand having an electric charge touches the front pattern 258a positioned on the front transparent film 257a, the electrostatic capacitance occurring on the front pattern 258a is transmitted to the rear pattern 258b by the connection line 258c. The touch panel 122 detects a signal according to an electrostatic capacitance of the rear pattern 258b at a position corresponding to the touch, and executes predetermined data corresponding to the touch position.

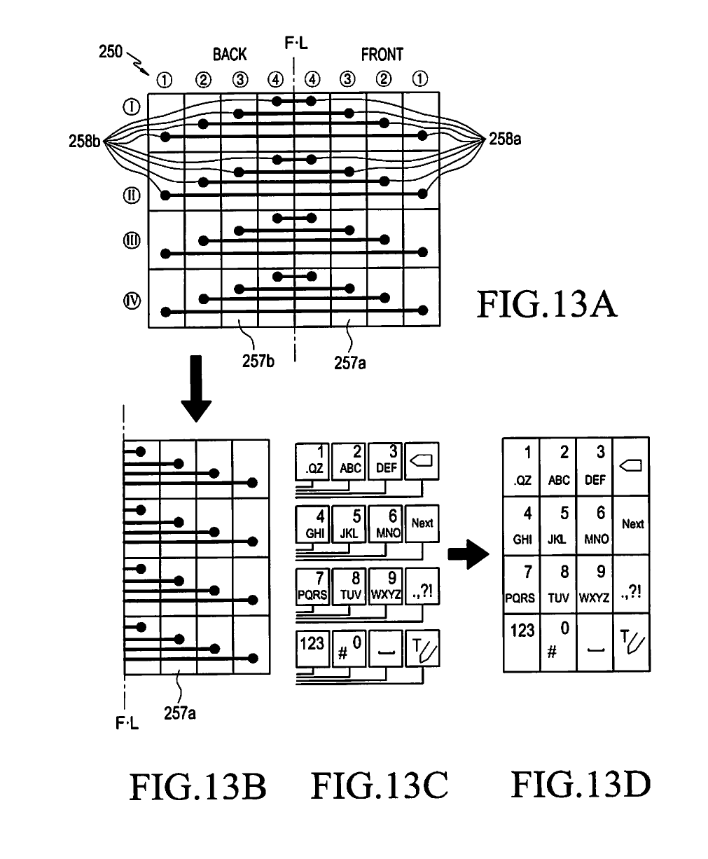

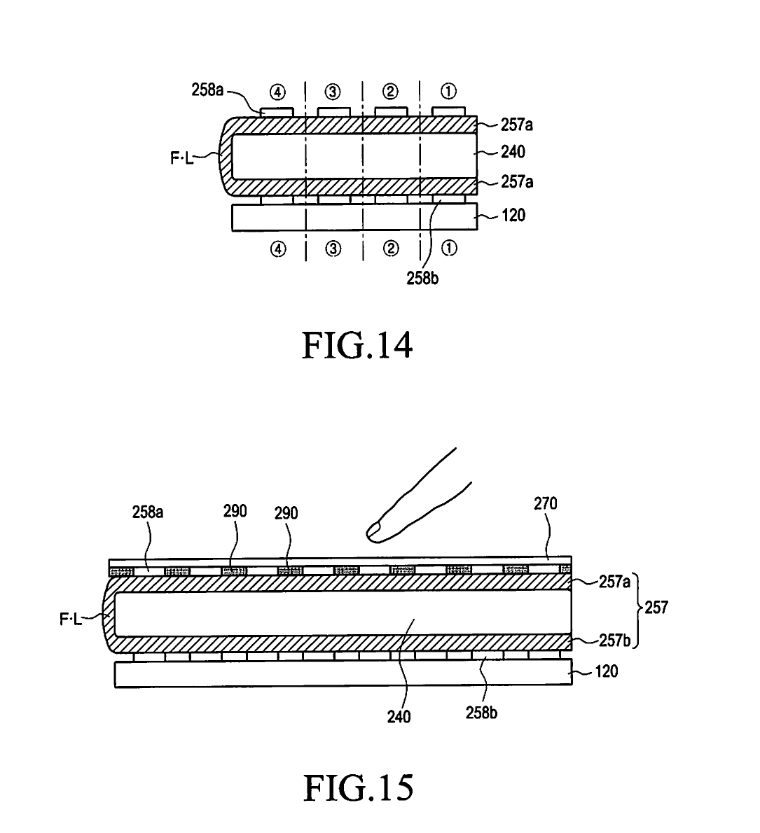

FIGS. 13A-13D are views illustrating an example of a transparent conductive film member for implementing an input in the cover member shown in FIG. 12, and FIG. 14 is a sectional view illustrating the cover member shown in FIG. 13. Referring to FIGS. 13 and 14, for example, the auxiliary output unit 240 has an input keypad in the form of 4*4 keys. In this case, the contact pattern 258 includes four front patterns 258a per column and four rear patterns 258b connected to the front patterns 258a, respectively. In the embodiment of the present invention, in the case that the input key has four columns and four lines, sixteen front patterns 258a and rear patterns 258b connected to the front patterns 258a, respectively, are provided to the input key. Further, the front pattern 258a and the rear pattern 258b are connected by the connection line 258c to be opposite to each other around the folding line F.L. That is, the front transparent film 257a and the rear transparent film 257b have an array of 8*4 in the unfolded state. Thus, the front transparent film 257a has four columns \textcircled{1}, \textcircled{2}, \textcircled{3}, and \textcircled{4} and four lines I, II, III, and IV from a right-most side with reference to the folding line F.L. (based on FIG. 13A), and the rear transparent film 257b has four columns \textcircled{1}, \textcircled{2}, \textcircled{3}, and \textcircled{4} and four lines I, II, III, and IV from a left-most side with reference to the folding line F.L. (based on FIG. 13A). In the state that the front transparent film 257a and the rear transparent film 257b are bent around the folding line F.L., the front pattern 258a and the rear pattern 258b in a line I are sequentially provided at positions (\textcircled{4}, \textcircled{4}), (\textcircled{3}, \textcircled{3}), (\textcircled{2}, \textcircled{2}), and (\textcircled{1}, \textcircled{1}) from an upper portion, respectively, in FIG. 13B. Similarly, in lines II, III, IV, the front pattern 258a and the rear pattern 258b are sequentially provided at positions (\textcircled{4}, \textcircled{4}), (\textcircled{3}, \textcircled{3}), (\textcircled{2}, \textcircled{2}), and (\textcircled{1}, \textcircled{1}) and are connected by the connection line 258c. In the case that the above-mentioned input keypad is implemented in the auxiliary output unit 240, for example, characters “ [symbol] (Samsung Electronics)” are input, when ‘8, 1, 2, and 0’ displayed through the auxiliary output unit 240 are pushed, electrostatic capacitance on the front pattern 258a varies at each position and electrostatic capacitance on the rear pattern connected to the front pattern varies. Thus, the rear pattern 258b corresponding to a touch position of the front pattern 258a is in contact with the touch panel 122 so that the predetermined ‘ [symbol] ’ characters can be input. In the same manner, when characters ‘8, 2, 1, and 0’ are pushed, characters ‘ [symbol] ’ are input, and when characters ‘9, 2, 1 and 5’ are pushed, characters ‘ [symbol] ’ are input. Further, when characters ‘9, 1, and 2’ are pushed, characters ‘ [symbol] ’ are input. In the embodiment of the present invention, an input of characters is described as an example, but is not limited thereto. For example, in the case that the auxiliary output unit 240 is set to display an identical screen to the display panel 121, when a user touches at least one application output through the auxiliary output unit 240, data corresponding to the application may be output through the auxiliary output unit 240.

In the embodiment of the present invention, it is described as an example that the auxiliary output unit has input keys of 4*4, but the input through the auxiliary output unit is not limited thereto. When many contact patterns 258 are distributed on the touch panel 122, it is obvious that the touch resolution of the touch panel 122 is improved.

FIG. 15 is a sectional view illustrating the transparent conductive film member shown in FIG. 13, in which the transparent conductive film member is provided with a conductive protective film. Referring to FIG. 15, the transparent conductive film member includes a pollution prevention member 290 capable of preventing an introduction of an alien substance between front patterns 258a provided on the front transparent film 257a, and a conductive protective film 270 capable of detecting a touch on the front pattern 258a. As described above, the conductive protective film 270 of the present invention is also made of a flexible transparent material with elasticity, allows a user to visually identify contents displayed on the auxiliary output unit 240, and is elastically pressed at a touch position.

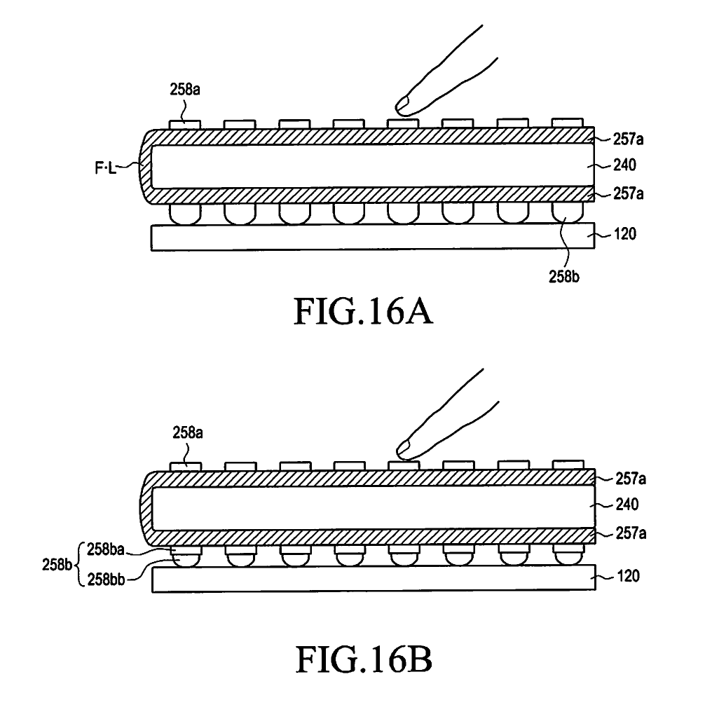

Hereinafter, two embodiments of the above-mentioned rear pattern 258b will be described. FIGS. 16A and 16B are sectional views illustrating another example of the transparent conductive film member shown in FIG. 13, in which the transparent conductive film member has a different pattern on a rear surface thereof Referring to FIG. 16, in one embodiment of the surface pattern 258b, the rear pattern 258b is made of an elastic material differently from the front pattern 258a (see FIG. 16A), and in the other embodiment, the rear pattern 258b includes a rear contact pattern 258ba and an elastic supporting portion 258bb (see FIG. 16B).

First, in FIG. 16A the rear pattern 258b according to one embodiment will be described. The rear pattern 258b is elastically provided to the input/output unit 120. That is, the rear pattern 258b is in direct contact with the input/output unit 120, particularly, the display panel 121. When a user pushes the front pattern 258a, the front pattern 258a is spaced at a predetermined distance from the input/output unit 120 and elastically pressed. The front pattern 258a is made of a conductive material. Then, the rear pattern 258b is in contact with the display panel 121 and prevents the display panel 121 from being scratched. Further, the rear pattern 258b transfers a touch on the front pattern 258a connected thereto to the touch panel 122.

In the other embodiment of FIG. 16B, as described above, the rear pattern 258b includes a rear contact pattern 258ba and the elastic supporting portion 258bb. The rear contact pattern 258ba is connected to the front contact pattern 258a by a connection line 258c, and the elastic supporting portion 258bb protrudes from the rear contact pattern 258ba and helps to elastically restore the rear contact pattern. Accordingly, in the state that the cover member 220 is folded on the input/output unit 120, the elastic supporting portion 258bb is in contact with the display panel 121, and the rear contact pattern 258ba is supported spaced from the display panel 121 by the elastic supporting portion 258bb. In this state, when a user touches the front pattern 258a, the elastic supporting portion 258bb connected to the front pattern 258a is pressed so as to make the rear contact pattern 258ba contact the display panel 121, particularly, the touch panel 122. Accordingly, as electrostatic capacitance of the touch panel 122 varies at a position corresponding to the touch on the rear contact pattern 258ba, the touch panel 122 detects the touch. Data corresponding to the touch position is output through the auxiliary output unit 240.

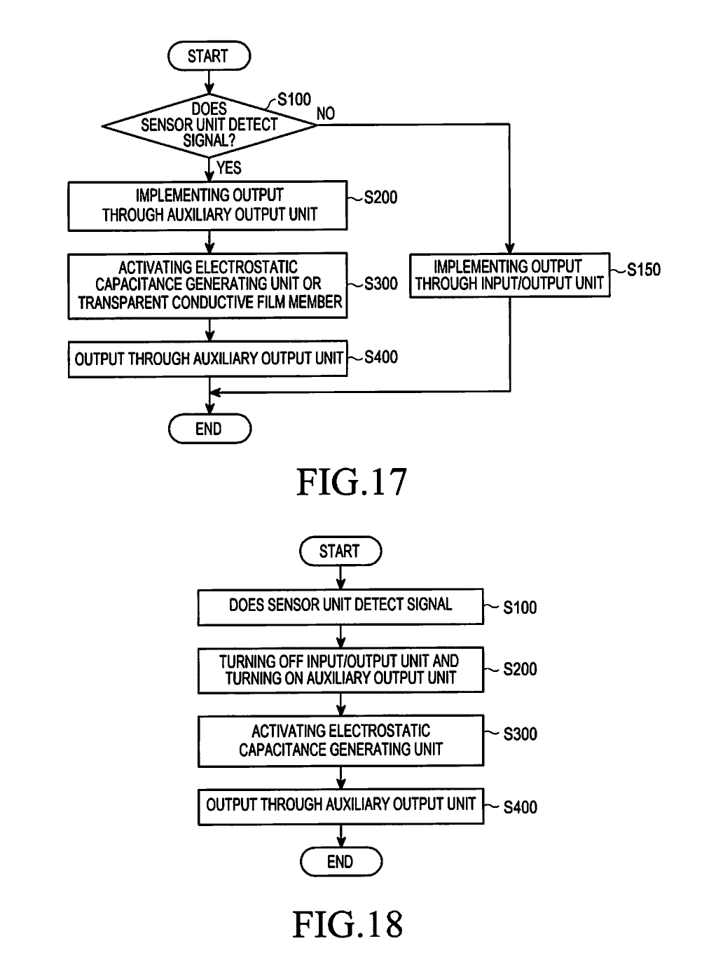

Hereinafter, an operation of implementing an input according to a folding or an unfolding of the cover unit in the device of embodiments of the present invention will be described. FIG. 17 is a flowchart illustrating an operation of the portable terminal according to a folding or an unfolding of the cover unit in the device shown in FIG. 1, and FIG. 18 is a flowchart in which the flowchart shown in FIG. 17 is briefly illustrated. Referring to FIGS. 17 and 18, the sensor unit 130 provided to the body 110 of the portable terminal 100 according to the present invention detects a signal in step S100. In the case that the sensor unit 130 does not detect the signal, the cover unit 200 is open and the input/output unit 120 is exposed. Accordingly, the controller 170 implements a display through the input/output unit 120 according to a detection value of the sensor unit 130 in step S150. Particularly, the controller 170 controls to turn on the touch panel 122 and the display panel 121, and to turn off the auxiliary output unit 240.

On the other hand, in the case that the sensor unit 130 detects a signal, the cover unit 200 is folded on a front surface of the body 110, and the input/output unit 120 is covered by the cover member 220 and opposite to the electrostatic capacitance generating unit 250 or the transparent conductive film member. Further, the auxiliary output unit 240 provided on the front surface of the cover member 220 is outwardly exposed to the front surface of the body. Therefore, the controller 170 controls an input and output through the auxiliary output unit 240 and the electrostatic capacitance generating unit 250 or the transparent conductive film member according to the detection value of the sensor unit 130 in step S200. Particularly, the controller 170 controls to turn off the display panel and to turn on the touch panel 122 and the auxiliary output unit 240. Accordingly, the electrostatic capacitance generating unit 250 or the transparent conductive film member 250 being opposite to and contacting the touch panel 122 is activated in step S300. When a user touches a specific data through the auxiliary output unit 240, the electrostatic capacitance generating unit 250 or the transparent conductive film member contacts the touch panel 122 at a touch position so as to implement an input, and the input value is output through the auxiliary output unit 240 in step S400.

The portable terminal provided with a cover device according to the various embodiments of the present invention can output predetermined contents through the cover unit in the state that the cover unit covers the portable terminal, in particular a touch screen. Further, although the cover unit is not open, contents output to the front surface of the cover unit can be identified and use of the portable terminal is convenient.

Further, since a simple structure is provided to the cover unit, an input to the portable terminal can be implemented according to a touch on the cover unit covering the touch screen.

Furthermore, as use of an input unit is activated, the touch panel associated with the input unit is also activated. Although the cover device covers the portable terminal, an input can be implemented. The output unit provided on the cover device does not require a unit such as a separate touch panel for implementing an input. Since a structure for a separate input is excluded from the cover device, it is possible to prevent an increase of a thickness of the cover device, and to reduce a cost.

Further, even if the cover device is not open, the user can identify the predetermined contents output to the front surface of the cover device. The frequency at which the cover device is open and closed can be reduced, resulting in the prevention of the cover device from being damaged and broken.

Although certain embodiments of the present invention, are described, it will be understood that various modifications can be implemented without departing from the scope of the present invention. For example, it is described as an example that the above mentioned sensor unit is mounted on a right upper portion of the body 110, but the mounting position of the sensor unit is not limited thereto. The sensor unit may be disposed at any position on the body 110 if it can detect a folding state of the cover unit 200. Further, the auxiliary output unit 240 of the present invention is described as a structure of the cover member 220, but it is contemplated that only the auxiliary output unit 240 constitutes the cover member. Accordingly, if necessary, the cover member can be variously modified. In this case, it is understood by those skilled in the art the cover member can be changed and modified without departing from the scope of the present invention.

Accordingly, the scope of the present invention shall not be determined by the above-described embodiments, and is to be determined by the following claims and their equivalents.

What is claimed is:

1. A cover device comprising:
a cover member having an output unit on a surface thereof, and coupled with a touch panel; and
an electrostatic capacitance generating unit which varies electrostatic capacitance of the touch panel at a touch position according to a touch on the output unit.

2. The cover device as claimed in claim 1, wherein the cover member is made of a flexible film or plastic.

3. The cover device as claimed in claim 1, wherein the output unit has an identical size to that of the touch panel and opposes the touch panel when the cover member overlays the touch panel.

4. The cover device as claimed in claim 1, wherein the electrostatic capacitance generating unit comprises:
an electrostatic pattern portion provided on an inner surface of the cover member opposite to the touch panel, and spaced at a predetermined distance from the touch panel; and
an elastic portion which supports and positions the electrostatic pattern portion to be spaced at a distance from the touch panel, and is elastically deformed according to the touch on the output unit.

5. The cover device as claimed in claim 4, wherein when a touch on a surface of the cover member occurs, the elastic portion is pressed at the touch position, and the electrostatic pattern portion contacts the touch panel at the touch position to implement an input.

6. The cover device as claimed in claim 4, wherein the electrostatic pattern portion comprises a plurality of electrostatic patterns adjacent to one another, and the elastic portion is disposed between the electrostatic patterns.

7. The cover device as claimed in claim 1, wherein the electrostatic capacitance generating unit comprises:
an electrostatic coating layer coated on an entire surface of the cover member; and
a supporting portion provided on a surface of the electrostatic coating layer which is divided into a plurality of regions, for supporting and spacing the electrostatic coating layer from the touch panel.

8. The cover device as claimed in claim 7, wherein the cover member is elastically deformed when being pressed.

9. The cover device as claimed in claim 8, wherein the supporting portion is provided in the form of a mesh pattern.

10. The cover device as claimed in claim 9, further comprising a conductive protective film on the output unit.

11. The cover device as claimed in claim 1, wherein the electrostatic capacitance generating unit comprises:
an electrostatic coating layer coated on an entire surface of the cover member;
a supporting portion provided on a surface of the cover member and supporting and spacing the electrostatic coating layer from the touch panel; and
a transfer portion provided between the supporting portion and connected to the electrostatic coating layer, and being in contact with the touch panel when the output unit is pressed.

12. The cover device as claimed in claim 11, further comprising a conductive protective film on the output unit.

13. The cover device as claimed in claim 1, wherein the cover member further comprises a fixed guide member which fixes the cover member to the touch panel so that the electrostatic capacitance generating unit is accurately positioned opposite to the touch panel.

14. The cover device as claimed in claim 13, wherein the fixed guide member includes side protrusion portions protruding from sides of the touch panel and fixing the cover member to the touch panel.

15. The cover device as claimed in claim 13, wherein the fixed guide member comprises:
a first magnetic member provided on a side periphery of the touch panel; and
a second magnetic member provided on a side periphery of the cover member, and engaged with the first magnetic member.

16. The cover device of claim 1, wherein the output unit has substantially the same size as the touch panel and opposes the touch panel when the cover member overlays the touch panel.

17. A cover device comprising:
an output unit; and
a transparent conductive film member wherein the transparent conductive film member is a continuous film and is provided on the front and rear surfaces of the output unit, so as to generate electrostatic capacitance at a same position.

18. The cover device as claimed in claim 17, wherein the transparent conductive film member comprises:
a transparent film portion folded and coupled with the front and rear surfaces of the output unit; and
a plurality of contact patterns provided on the transparent film portion, and connected to one another to generate electrostatic capacitance at the same position when the transparent film portion is folded.

19. The cover device as claimed in claim 18, wherein the transparent film portion is folded and opposite to itself around a folding line, and comprises:
a front transparent film provided on a front surface of the output unit; and
a rear transparent film folded on the front transparent film, and provided on a rear surface of the output unit,
wherein the folding line bisects the transparent film portion so that the rear transparent film is folded on the front transparent film.

20. The cover device as claimed in claim 19, wherein the contact patterns comprise:
at least one front pattern provided on the front transparent film; and
at least one rear pattern provided on the rear transparent film and connected to the at least one front pattern, such that the rear pattern is at a position corresponding to that of the front pattern when the transparent film portion is folded.

21. The cover device as claimed in claim 20, further comprising a transparent pollution protection member between the front patterns.

22. The cover device as claimed in claim 21, further comprising a protective film on the output unit.

23. The cover device as claimed in claim 20, wherein the rear pattern includes a conductor made of an elastic material.

24. The cover device as claimed in claim 18, wherein the contact patterns include an Indium Tin Oxide (ITO) pattern.

25. The cover device as claimed in claim 18, further comprising: a transparent pollution protection member between the contact patterns.

26. A portable terminal having a cover device, comprising:
a body including an input/output unit; and
a cover member coupled with the body for covering the body, and provided with an auxiliary output unit on a front surface thereof,
wherein the cover member comprises an electrostatic capacitance generating unit which implements an input to the input unit of the input/output unit according to a touch on the auxiliary output unit.

27. The portable terminal as claimed in claim 26, wherein the electrostatic capacitance generating unit comprises:
an electrostatic pattern provided on a rear surface of the cover member and spaced at a predetermined distance from the input/output unit; and
an elastic portion which supports and positions the electrostatic pattern portion to be spaced at a distance from the input/output unit, and is elastically deformed according to the touch on the auxiliary output unit.

28. The portable terminal as claimed in claim 26, wherein the electrostatic capacitance generating unit comprises:
an electrostatic coating layer coated on an entire surface of the cover member; and
a supporting portion provided on a surface of the electrostatic coating layer which is divided into a plurality of regions, for supporting and spacing the electrostatic coating layer opposite to the input/output unit.

29. The portable terminal as claimed in claim 26, wherein the electrostatic capacitance generating unit comprises:
an electrostatic coating layer coated on an entire surface of the cover member;
a supporting portion provided on a surface of the cover member and supporting and spacing the electrostatic coating layer from the touch panel; and
a transfer portion provided between the supporting portion and connected to the electrostatic coating layer, and being in contact with the input/output unit, when the auxiliary output unit is pressed.

30. The portable terminal as claimed in claim 26, wherein the cover unit comprises:
a rear cover coupled to the body; and
a front cover rotatably coupled with the rear cover, and covering the input/output unit,
wherein the front cover includes the auxiliary output unit and the electrostatic capacitance generating unit.

31. A portable terminal having a cover device, comprising:
a body including an input/output unit; and
a cover member coupled with the body for covering the body, and provided with an auxiliary output unit on a front surface thereof,
wherein the cover member includes a transparent conductive film member which is provided on front and rear surfaces of the auxiliary output unit and generates electrostatic capacitance at a same position.

32. The portable terminal as claimed in claim 31, wherein the transparent conductive film member comprises:
a transparent film portion folded and coupled with the front and rear surfaces of the auxiliary output unit; and
a plurality of contact patterns provided on the transparent film portion, and connected to one another to generate electrostatic capacitance at the same position when the transparent film portion is folded.

33. The portable terminal as claimed in claim 32, wherein the transparent film portion includes a front transparent film provided on a front surface of the auxiliary output unit around a folding line and a rear transparent film provided on a rear surface of the auxiliary output unit, and the contact patterns include a front pattern provided on the front transparent film and a rear pattern provided on the rear transparent film and connected to the front pattern, such that the rear pattern is at a same position as that of the front pattern when the transparent film portion is folded.
